(19) United States
(12) Patent Application Publication
(10) Pub. No.: US 2010/0082400 A1
(43) Pub. Date: Apr. 1, 2010

(54) SCORING CLICKS FOR CLICK FRAUD PREVENTION

(75) Inventors: Abraham Bagherjeiran, Sunnyvale, CA (US); Nicolas Eddy Mayoraz, Cupertino, CA (US); Dragomir Yankov, Sunnyvale, CA (US); Rajesh Parekh, San Jose, CA (US)

Correspondence Address: Weaver Austin Villeneuve & Sampson - Yahoo!, P.O. BOX 70250, OAKLAND, CA, 94612-0250, US

(73) Assignee: Yahoo! Inc.., Sunnyvale, CA (US)

(21) Appl. No.: 12/240,675

(22) Filed: Sep. 29, 2008

(51) Int. Cl. G06Q 30/00; G06N 5/02; G06Q 10/00

(52) U.S. Cl. 705/10; 706/47; 705/34

(57) ABSTRACT

Machine learning techniques are employed to build and evolve classifiers (e.g., decision trees or other rule-based classifiers) which generate scores representing confidence values associated with particular paths through a classifier (rather than discrete class labels), and then compare those scores to tunable thresholds to effect classification.

### BACKGROUND OF THE INVENTION

The present invention relates to techniques for improving the performance of classification systems and, in particular, click fraud detection systems.

“Click-based” online advertising systems require an advertiser to pay the system operator or its partners each time a user selects or “clicks” on the advertiser's online advertisement or sponsored search link. Unfortunately, the nature of such a system provides opportunities for some to click on ads for improper or fraudulent reasons. This is referred to generally as “click fraud.” For example, a provider of online advertising services may partner with a third party to place ads for an advertiser on the third party's web site with a portion of the revenue for each click going to the third party. This provides a financial incentive for the third party to click the links on its own site. In another example, one company might be motivated to click on the ads of a competitor to drive up advertising costs for the competitor. Some click fraud efforts are fairly large in scale with groups of people being paid to engage in such activity, i.e., “click farms.” There are even automated processes for engaging in click fraud, e.g., web crawling bots, ad-ware, and various kinds of mal-ware.

The rapid rise in click-based online advertising, and the ease with which click fraud may be perpetrated has spurred the development of systems designed to detect click fraud. Such systems evaluate click events with reference to one or more of a wide range of criteria to determine whether a click is “good,” e.g., a valid click by an interested consumer, or “bad,” i.e., a fraudulent click. For example, clicks by self-declared bots may be automatically identified as fraudulent. In addition, a large number of clicks from the same user within a specified period of time may be identified as fraudulent. The clicks are then filtered on this basis and the advertisers billed accordingly.

FIG. 1 shows a population 100 of click events that may be divided between “good” or valid events 102, and “bad” or invalid/fraudulent events 104. A subset of events defined by box 106 represents events which are filtered by a fraud detection system, i.e., identified as fraudulent. As shown, some of the filtered events are actually good events, i.e., false positives (valid events which are incorrectly identified as invalid or fraudulent), while some of the bad events are not filtered, i.e., false negatives (invalid or fraudulent events which are incorrectly identified as valid). The goal of any fraud detection system is to minimize one or both of these event subsets, i.e., to have the filtered events 106 correspond as closely as possible to the bad events 104. Unfortunately, it is extremely difficult to evaluate the performance of a click fraud detection system in that it is difficult, if not impossible, to determine the number of false negatives. That is, a false negative is difficult to identify because there is no evidence that the click event identified as valid is fraudulent, i.e., it is indistinguishable from many other valid click events.

Thus, because it is nearly impossible to distinguish false negatives from valid events, it is extremely difficult to evaluate the performance of click fraud detection systems. This is problematic in that it undermines advertisers' confidence that they are paying for valid events.

### SUMMARY OF THE INVENTION

According to a particular class of embodiments of the present invention, methods and apparatus are provided for classifying click events. Each click event corresponds to selection of an object in a user interface. A first score is determined with reference to click event data representing a first one of the click events using a first classifier. The first classifier represents a first plurality of rules. Each of the first plurality of rules corresponds to at least one path through the first classifier and has one of a first plurality of scores associated therewith. Each of the first plurality of scores represents a probability that a corresponding one of the click events satisfying the corresponding rule is valid. The first click event is classified by comparing the first score with a first tunable threshold.

According to specific embodiments, the scores represent probabilities that corresponding ones of the click events will lead to conversion events. According to specific embodiments, the scores represent increasing probability over time that corresponding ones of the click events that are repeat click events will lead to conversion events.

According to specific embodiments, the click events correspond to selection of sponsored search advertisements. According to more specific embodiments, a first advertiser is billed in response to classification of the first click event.

According to specific embodiments, the first tunable threshold is modified. According to specific embodiments, the scores are periodically modified using a machine learning technique with reference to conversion data representing actual conversion events.

According to specific embodiments, the first classifier is configured to filter repeat click events. A second score is determined with reference to second click event data representing the first click event using a second classifier configured to filter selected ones of the click events that are unlikely to lead to conversion events. The second classifier represents a second plurality of rules. Each of the second plurality of rules corresponds to at least one path through the second classifier and has one of a second plurality of scores associated therewith. Each of the second plurality scores represents a probability that a corresponding one of the click events satisfying the corresponding rule is valid. The first click event is classified by comparing the second score with a second tunable threshold.

A further understanding of the nature and advantages of the present invention may be realized by reference to the remaining portions of the specification and the drawings.

### BRIEF DESCRIPTION OF THE DRAWINGS

FIG. 1 is a diagram illustrating an event set for evaluation by a fraud detection system.

FIG. 2 is a simplified diagram of an example of a click fraud detection system designed in accordance with a specific embodiment of the invention.

FIG. 3 is a representation of a portion of simple decision tree for illustrating the operation of decision trees which may be used with particular embodiments of the invention.

FIGS. 4-6 show tables of click event features and related information for use with specific embodiments of the invention.

FIG. 7 is a simplified representation of a computing environment in which embodiments of the present invention may be implemented.

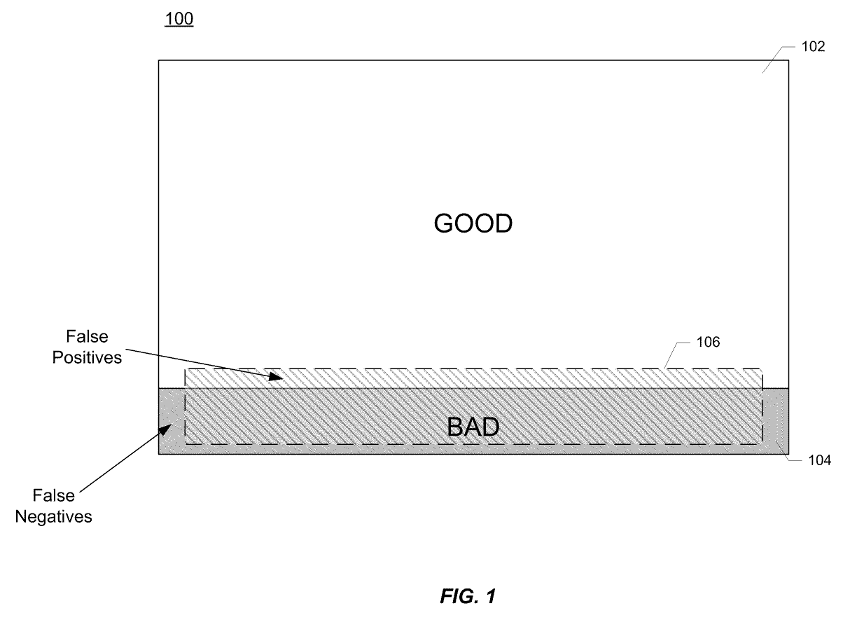

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

According to various embodiments of the invention, machine learning techniques are employed to build and evolve classifiers (e.g., decision trees or other rule-based classifiers) which generate scores representing confidence values associated with particular paths through a classifier (rather than discrete class labels), and then compare those scores to tunable thresholds to effect classification.

According to one class of embodiments of the invention, one or more classifiers are employed to filter click events in the context of sponsored search advertising. The classifiers are implemented as rule-based classifiers (e.g., decision trees) which, instead of the conventional application of class labels to leaf nodes, generate scores which represent a likelihood that the click event is a valid click event. These scores are then compared to a tunable threshold to determine whether the click event should be filtered or not. It should be noted that the term “click event” as used herein is not limited to activation of a conventional computer mouse button, but more generally refers to selection of an object of any kind in any kind of user interface.

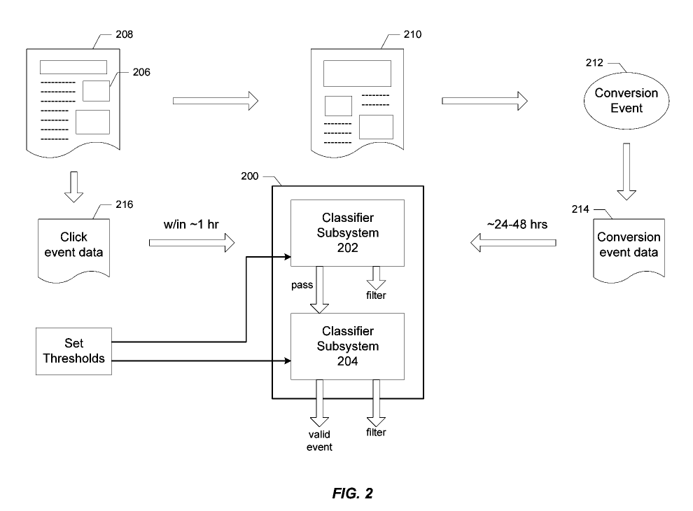

A specific implementation of a system 200 for filtering click events is shown in FIG. 2. The system includes two classifier subsystems; a first classifier subsystem 202 and a second classifier subsystem 204. Operation of system 200 will be described with reference to the classification of a click event relating to a sponsored search link 206 in the context of a search results web page 208. However, it should be understood that the basic principles underlying the present invention are applicable to a much broader range of classifiers and objects or events to be classified. Therefore, the present invention should not necessarily be limited by references to this particular context.

When a user clicks on link 206, the user's browser is directed to a landing page 210 (on a site typically operated by the advertiser) by which some form of desired transaction may be initiated, e.g., a purchase of a product. Such a transaction is generally referred to as a conversion event 212. Data regarding conversion events (214) are typically reported back to the operator of the sponsored search advertising system (which may include system 200) 24 to 48 hours after the conversion event. As will be discussed, according to some embodiments, such conversion event data may be employed for system calibration and/or learning.

As part of the determination as to whether to treat the click event as a valid event (and therefore charge the advertiser), click event data 216 representing the click event are provided as input to system 200. These click event data may include any of a wide variety of features available at the time of the click event such as, for example, a time stamp, query keyword(s), a user ID, a session ID, a search ID, an IP address, etc. Other features derived or aggregated over some period of time, e.g., the one-hour period beginning, ending, or surrounding the click event, may be provided as input such as, for example, the existence and/or number of similar click events. System 200 then determines whether the click event should be filtered, i.e., is likely to be a fraudulent click event, or if it should be counted as a valid click event, e.g., is likely to lead to a conversion event.

First classifier subsystem 202 employs a machine learning classifier that filters out the majority of the filtered click events by selectively filtering out repeat clicks, e.g., similar click events occurring within some period of time of a corresponding previous click event. The similarity between click events may be identified with reference to a number of click event features including, for example, user ID, session ID, search ID, IP address, etc. Operation of this subsystem is based on the notion that similar click events spaced closely in time are likely to be fraudulent. However, in contrast with previous approaches, the manner in which subsystem 202 is implemented takes into account that some apparently repeat click events occurring close in time may be valid events, and further that the likelihood that a repeat click event is valid increases with time elapsed from the previous similar click event. Thus, although subsystem 202 may depend to some degree on the time between similar click events, it does not rigidly apply a time-based rule like previous classifiers.

Second classifier subsystem 204 also employs a machine learning classifier that filters out click events with reference to another set of rules applied to a different (but possibly overlapping) and typically much larger set of click event features. The goal of classifier subsystem 204 is to identify click events that have a high probability of leading to a conversion event (or, conversely, to identify those that do not).

Because of the disadvantages associated with binary decision making in the context of click fraud detection, and according to a particular class of embodiments of the invention, the filter rates of each of these subsystems is made to be tunable so that the filter rates may be adjusted while maintaining a high level of confidence in the accuracy of the filtering decisions. That is, instead of using a binary decision making protocol to filter click events, i.e., a “good” vs. “bad” determination, each classifier subsystem scores each click event with reference to some relevant set of click event features, and compares the score to a tunable threshold θ. The threshold θ may be manipulated, for example, by an authorized business user associated with the provider of sponsored search advertising services to produce a predictable effect on revenues.

In addition, and according to various embodiments, the classifier subsystems employ actual conversion data (e.g., data 214) for calibration, and to learn over time to effect automatic adjustment of their operation such that the scores generated for click events more accurately reflect the likelihood that the click events are valid (or fraudulent). This avoids the heavy and undesirable reliance on manual tuning by which previous click fraud detection systems have been characterized.

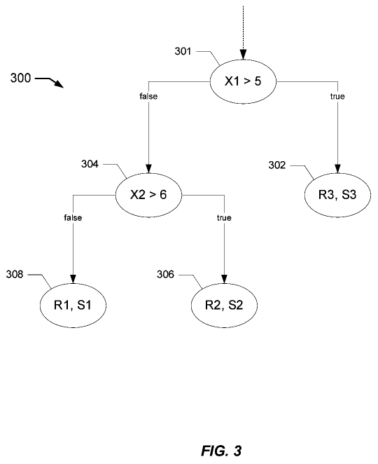

A simple representation of a portion of a decision tree by which operation of classifiers for use with the present invention might be governed is shown in FIG. 3. In this example, the click event features are denoted X1 and X2, and each of the leaf nodes of decision tree 300 are denoted with a rule number R1, R2, and R3 which represents the path through the decision tree to reach that leaf node. As shown at decision node 301, if the value of X1 is greater than 5, the decision tree proceeds to leaf node 302 and the click event is assigned a corresponding score S3 (as opposed to a binary decision). If, on the other hand, the value of X1 is less than or equal to 5, the decision tree proceeds to decision node 304 which compares X2 to the value 6. If X2 is greater than 6, the decision tree proceeds to leaf node 306 and the click event is assigned a corresponding score S2. If the value of X2 is less than or equal to 6, the decision tree proceeds to leaf node 308, and the click event is assigned a corresponding score S1.

Thus, rule R1 and its corresponding score is represented by X1≦5 [symbol] X2≦6; rule R2 and its corresponding score by X1≦5 [symbol] X2>6; and rule R3 and its corresponding score X1>5. So, instead of having class labels (e.g., pass/fail, good/bad, valid/invalid) associated with the decision tree leaf nodes, embodiments of the present invention instead associate scores which represent a likelihood that the click event is a valid one, e.g., has a high probability of leading to a conversion event. The ultimate class label (i.e., the filtering decision) is not applied until a comparison with the tunable threshold θ is done. It will be understood that this is merely a simple example of a type of decision tree which may be used with various embodiments of the invention. In addition, embodiments are contemplated in which pruning of rules in a decision tree may result in a classifier which is no longer technically a decision tree, e.g., the rules may be overlapping in the sets of corresponding trigger points. More generally, the present invention may be implemented using a wide variety of rule-based classifiers, of which decision trees are merely one example.

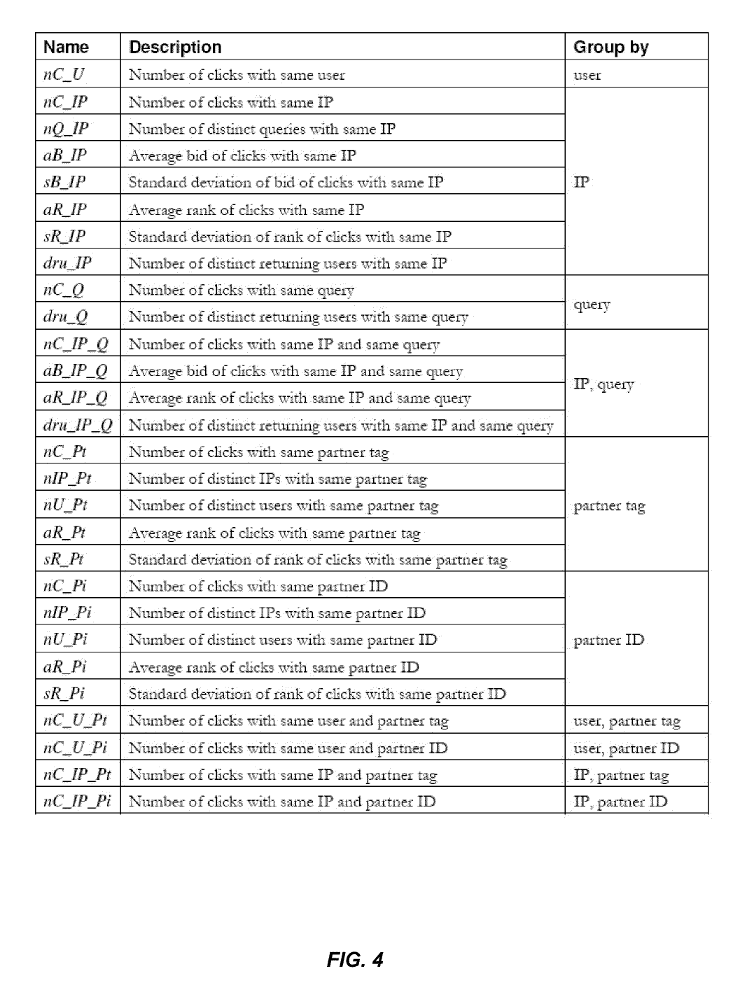

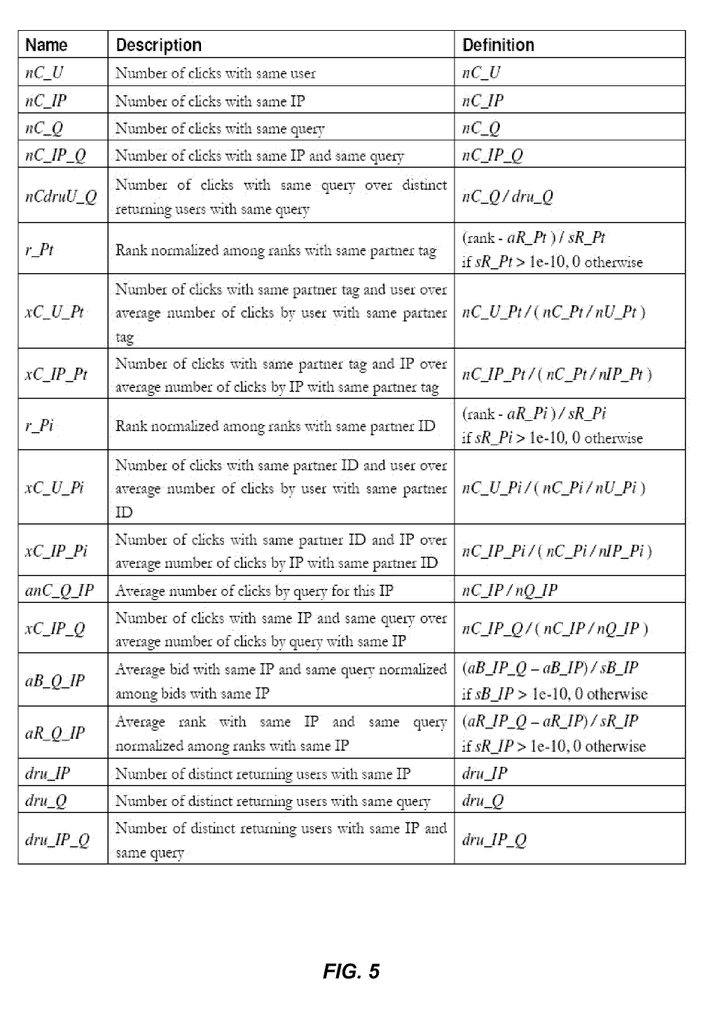

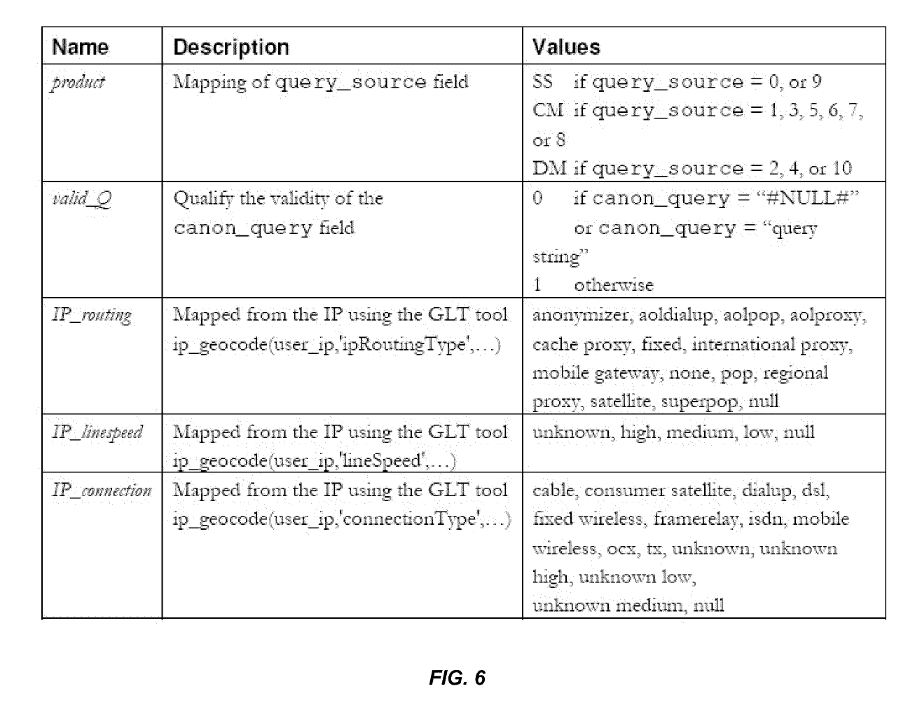

FIGS. 4, 5, and 6 show tables which illustrate at least some of the possible click event features which may be employed (e.g., click event data 216) by one or both of the classifiers described above. The features of FIG. 5 are mathematical expressions of one or more numerical quantities that are basic aggregates defined in FIG. 4. Each one of the features of FIG. 5 is computed based on a set of all the clicks (valid and invalid) that occurred within a time window of one hour. According to a specific embodiment, the 1 hour time window used for the computation of each feature is a sliding window moving at fixed 5 minutes intervals. In other words, all features for clicks that occurred in time range [t-5′, t] are computed simultaneously based on aggregations in time window [t-60′, t], where t is either h:00, h:05, . . . , h:55, for any possible hour h. FIG. 6 shows some categorical click event features for use with various embodiments of the invention which relate to the user query to which the clicked sponsored search results was responsive, as well as the nature of the internet connection of the clicker. As will be understood, the features shown are merely examples of click event features in the context of sponsored search advertising. A wide variety of features relating to a wide variety of events or objects (depending on what is being classified) may be used with other embodiments of the invention.

Any of a wide range of suitable machine learning techniques may be applied to the relevant click event feature sets and known training data to build and evolve each of the classifier subsystems. For example, embodiments of the invention may employ decision trees and other rule-based classifiers implemented using any of a variety of sophisticated data mining tools such as, for example, ID3, C4.5, C5.0, etc. For additional information relating to such tools, reference may be made to C4.5: Programs for Machine Learning by J. Ross Quinlan, Morgan Kaufmann (1993), the entire disclosure of which is incorporated herein by reference for all purposes. According to particular implementations, and as described below, the training data sets used were relatively large and included actual conversion event data so that the confidence values for each rule or path through the classifier more closely approximated the real world probabilities that particular click events would result in a corresponding conversion event. These values are then used as the scores associated with each rule. The classifier may then be periodically and automatically retrained on new training data to ensure that the scores being used are reflective of real-world probabilities.

According to a particular embodiment, the training process includes three phases: building a rule set; scoring rule subsets; and fixing thresholds for binary classification. In the first phase, a set of rules is built that is designed to discriminate between two sets of clicks, i.e., suspected good clicks and suspected bad clicks. Let Σ denote the set of rules generated in the first phase. For a given click x, let S(x)⊂Σ denote the subset of rules that are satisfied by click x. A subset of rules S⊂Σ is defined as feasible if there exists at least one click x such that S(x)=S, i.e., x satisfies all the rules in S and no other.

The second phase, also referred to as the calibration phase, assigns a score and a confidence for this score to every feasible subset of rules. The final score assigned to a particular click x is given by the score of the feasible subset S(x). The score of a feasible subset of rules S is defined as an approximation of the posterior probability of a click x to convert given that S(x)=S:

Score(x)=Score(S(x))=Pr(x convert|S(x))

Note that under independence assumptions between valid clicks and conversions conditional to S(x), these scores can be turned into probabilities of clicks to be valid through a simple linear transformation of scale Pr(Valid)/Pr(Conversion).

Once all the clicks are scored, a threshold θ in the score range [0, 1] is determined such that a click with score higher than θ is classified as valid, while a click with a score lower than θ is labeled invalid. One way to choose this threshold θ is to pick the one that yields an overall system that has a desired revenue impact, e.g., increase, decrease, or neutral, relative to a previous filtering system being replaced. Alternatively, the threshold may be picked to optimize a metric M assessing the quality of a filter (discussed below).

According to a particular embodiment of classifier subsystem 202, a decision to filter a duplicate click x is represented as a function of time and of the click itself as follows:

Filter(x,t)IF t≦T₁ OR [t≦T₂ AND Pr(convert|x,t)≦θ]

The first time threshold T₁ guarantees that duplicates with short time to duplication are unconditionally filtered. Its value may be selected based on business criteria. For an evaluation of this approach, T₁ was set to 10 minutes. The second time threshold T₂ ensures that beyond some time, no click will be filtered as a duplicate. For our evaluation, T₂ was set to one hour or 60 minutes. Note that whenever T2 is no more than T1, the Pr(convert|x,t) becomes irrelevant, yielding a strictly time-based filter. As will be understood, a wide range of values for each of these thresholds may be used.

According to a particular implementation, the design of classifiers 202 and 204 was guided by two metrics M₀ and M₁ which are given by:

M₀(F)=Pr(x valid|x filtered by filter F); and

M₁(F)=w_{FP}·Pr(valid click is filtered by filter F)+w_{FN}·Pr(invalid is not filtered by filter F)

Both metrics M₀ and M₁ cannot be computed exactly, as valid clicks are not known. Therefore, approximations are based on the assumption that he probability of a valid click to be filtered is equal to the probability of a converting click to be filtered. That is, these metrics account for the potential bias between valid clicks and conversions, with an estimated correction factor. For more information regarding the evaluation of a classifier with reference to such metrics, refer to U.S. patent application Ser. No. 11/612,004 for EVALUATING PERFORMANCE OF BINARY CLASSIFICATION SYSTEMS filed on Dec. 18, 2006 (Attorney Docket No. YAH1P050/Y01775US00), the entire disclosure of which is incorporated herein by reference for all purposes.

According to various embodiments, the threshold θ in the filter functions described above may be selected based on metrics M₀ and M₁. According to a particular approach, techniques from multi-criteria optimization may be used. According to one such approach, two extreme thresholds are singled out. The first one, θ₀, is obtained by optimizing M₀ under the constraint that the filter outperforms a strictly time-based filter on M₁. The second one, θ₁, is just the opposite as it results in the optimization of M₁ under the constraint that M₀ is at least as good as it is for the time-based filter. Given the known respective biases of M₀ and M₁, threshold θ₀ yields the most conservative filter, leaving a lot of duplicates unfiltered; while θ₁ yields the more aggressive filter, removing most of the duplicates. As will be appreciated, there may be a range of other thresholds of interest between these two extremes.

According to some embodiments, the thresholds θ for one or both of classifiers 202 and 204 may be selected with reference to a desired effect on revenues. That is, the effects of different thresholds may be empirically determined using past data, and the correlation of these effects with the different thresholds communicated to business users so that such users may appropriately adjust the threshold(s) to achieve a desired effect on revenue.

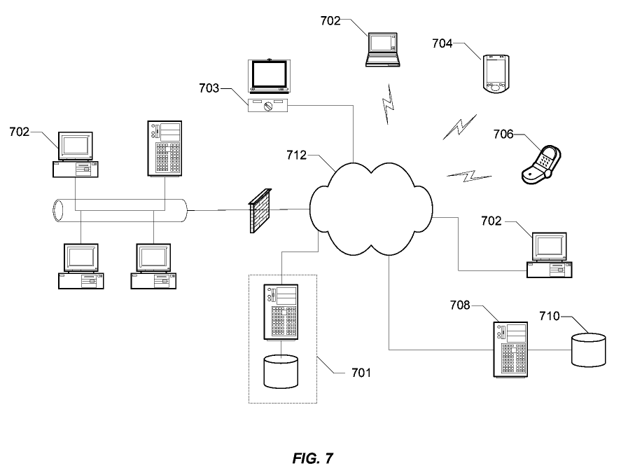

Embodiments of the present invention may be employed to classify events, e.g., click events, or objects in any of a wide variety of computing contexts. For example, as illustrated in the diagram of FIG. 7, implementations are contemplated in which a population of users interacts with a diverse network environment via any type of computer (e.g., desktop, laptop, tablet, etc.) 702, media computing platforms 703 (e.g., cable and satellite set top boxes and digital video recorders), mobile computing devices (e.g., PDAs) 704, cell phones 706, or any other type of computing or communication platform. The population of users might include, for example, users of online search services and sponsored search advertising services such as those provided by Yahoo! Inc. Other entities involved in various embodiments of the invention might include, for example, advertisers, advertising partners, merchants, etc. (represented by web site 701). However, it should again be noted that click events in the context of sponsored search advertising are only examples of events or objects which may be classified according to the invention.

Regardless of the nature of the events or objects being classified, they may be processed in accordance with an embodiment of the invention in some centralized manner. This is represented in FIG. 7 by server 708 and data store 710 which, as will be understood, may correspond to multiple distributed devices and data stores. The invention may also be practiced in a wide variety of network environments including, for example, TCP/IP-based networks, telecommunications networks, wireless networks, public networks, private networks, various combinations of these, etc. Such networks, as well as the potentially distributed nature of some implementations, are represented by network 712.

In addition, the computer program instructions with which embodiments of the invention are implemented may be stored in any type of tangible computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. For example, embodiments have been described herein relating to the classification of click events in the context of sponsored search advertising. However, it should be understood that classifiers implemented according to various embodiments of the invention may be applied to classify events or objects in a much broader range of applications. For example, embodiments of the invention may be implemented to classify click events in the context of contextual advertising. More broadly, a wide variety of decision tree and other rule-based classifiers may be improved using the techniques described herein.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for classifying click events, each click event corresponding to selection of an object in a user interface, comprising:
determining a first score with reference to click event data representing a first one of the click events using a first classifier, the first classifier representing a first plurality of rules, each of the first plurality of rules corresponding to at least one path through the first classifier and having one of a first plurality of scores associated therewith, each of the first plurality of scores representing a probability that a corresponding one of the click events satisfying the corresponding rule is valid; and
classifying the first click event by comparing the first score with a first tunable threshold.

2. The method of claim 1 wherein the scores represent probabilities that corresponding ones of the click events will lead to conversion events.

3. The method of claim 1 wherein the scores represent increasing probability over time that corresponding ones of the click events that are repeat click events will lead to conversion events.

4. The method of claim 1 wherein the click events correspond to selection of sponsored search advertisements.

5. The method of claim 4 further comprising billing a first advertiser in response to classification of the first click event.

6. The method of claim 1 wherein the click event data comprise one or more of a user identifier, a session identifier, a device identifier, connection information, an IP address, search information, an advertising partner identifier, a search result rank, or a number of clicks.

7. The method of claim 1 further comprising modifying the first tunable threshold.

8. The method of claim 1 further comprising periodically modifying the scores using a machine learning technique with reference to conversion data representing actual conversion events.

9. The method of claim 1 wherein the first classifier is configured to filter repeat click events, the method further comprising:
determining a second score with reference to second click event data representing the first click event using a second classifier configured to filter selected ones of the click events that are unlikely to lead to conversion events, the second classifier representing a second plurality of rules, each of the second plurality of rules corresponding to at least one path through the second classifier and having one of a second plurality of scores associated therewith, each of the second plurality scores representing a probability that a corresponding one of the click events satisfying the corresponding rule is valid; and
classifying the first click event by comparing the second score with a second tunable threshold.

10. A computer program product for classifying click events, each click event corresponding to selection of an object in a user interface, the computer program product comprising at least one computer-readable medium having first computer program instructions stored therein which, when executed by a computing device, cause the computing device to:
determine a first score with reference to first click event data representing a first one of the click events using a first classifier, the first classifier representing a first plurality of rules, each of the first plurality of rules corresponding to at least one path through the first classifier and having one of a first plurality of scores associated therewith, each of the first plurality of scores representing a probability that a corresponding one of the click events satisfying the corresponding rule is valid; and
classify the first click event by comparing the first score with a first tunable threshold.

11. The computer program product of claim 10 wherein the scores represent probabilities that corresponding ones of the click events will lead to conversion events.

12. The computer program product of claim 10 wherein the scores represent increasing probability over time that corresponding ones of the click events that are repeat click events will lead to conversion events.

13. The computer program product of claim 10 wherein the click events correspond to selection of sponsored search advertisements.

14. The computer program product of claim 13 wherein the first computer program instructions are further configured to cause the computing device to bill a first advertiser in response to classification of the first click event.

15. The computer program product of claim 10 wherein the click event data comprise one or more of a user identifier, a session identifier, a device identifier, connection information, an IP address, search information, an advertising partner identifier, a search result rank, or a number of clicks.

16. The computer program product of claim 10 wherein the first computer program instructions are further configured to cause the computing device to modify the first tunable threshold.

17. The computer program product of claim 10 wherein the first computer program instructions are further configured to cause the computing device to periodically modify the scores using a machine learning technique with reference to conversion data representing actual conversion events.

18. The computer program product of claim 10 wherein the first classifier is configured to filter repeat click events, the at least one computer-readable medium having second computer program instructions stored therein which, when executed by the computing device, cause the computing device to:
determine a second score with reference to second click event data representing the first click event using a second classifier configured to filter selected ones of the click events that are unlikely to lead to conversion events, the second classifier representing a second plurality of rules, each of the second plurality of rules corresponding to at least one path through the second classifier and having one of a second plurality of scores associated therewith, each of the second plurality scores representing a probability that a corresponding one of the click events satisfying the corresponding rule is valid; and
classify the first click event by comparing the second score with a second tunable threshold.

19. A click-based advertising system responsive to click events, each click event corresponding to selection of an advertisement in a user interface, the system comprising at least one computing device configured to:
determine a first score with reference to click event data representing a first one of the click events using a first classifier, the first classifier representing a first plurality of rules, each of the first plurality of rules corresponding to at least one path through the first classifier and having one of a first plurality of scores associated therewith, each of the first plurality of scores representing a probability that a corresponding one of the click events satisfying the corresponding rule will lead to a conversion event;
classify the first click event by comparing the first score with a first tunable threshold; and
bill a first advertiser in response to classification of the first click event.

20. The system of claim 19 wherein the scores represent increasing probability over time that corresponding ones of the click events that are repeat click events will lead to conversion events.

21. The system of claim 19 wherein the click event data comprise one or more of a user identifier, a session identifier, a device identifier, connection information, an IP address, search information, an advertising partner identifier, a search result rank, or a number of clicks.

22. The system of claim 19 wherein the at least one computing device is further configured to modify the first tunable threshold.

23. The system of claim 19 wherein the at least one computing device is further configured to periodically modify the scores using a machine learning technique with reference to conversion data representing actual conversion events.

24. The system of claim 19 wherein the first classifier is configured to filter repeat click events, and wherein the at least one computing device is further configured to:
determine a second score with reference to second click event data representing the first click event using a second classifier configured to filter selected ones of the click events that are unlikely to lead to conversion events, the second classifier representing a second plurality of rules, each of the second plurality of rules corresponding to at least one path through the second classifier and having one of a second plurality of scores associated therewith, each of the second plurality scores representing a probability that a corresponding one of the click events satisfying the corresponding rule is valid; and
classify the first click event by comparing the second score with a second tunable threshold.
